(19) United States
(12) Patent Application Publication
(10) Pub. No.: US 2024/0019862 A1
(43) Pub. Date: Jan. 18, 2024

(54) CONTROL APPARATUS, CONTROL METHOD, AND PROGRAM

(71) Applicant: Nippon Telegraph and Telephone Corporation, Tokyo (JP)

(72) Inventors: Masaru Sakai, Musashino-shi, Tokyo (JP); Kensuke TAKAHASHI, Musashino-shi, Tokyo (JP)

(21) Appl. No.: 18/268,375

(22) PCT Filed: Jan. 8, 2021
(86) PCT No.: PCT/JP2021/000482

§ 371 Date: Jun. 20, 2023

(51) Int. Cl. G05B 23/02

(52) U.S. Cl. CPC G05B 23/0283; G05B 23/024

(57) ABSTRACT

Provided is a control device 10 for controlling an operation phase of a maintenance control system, wherein the system performs maintenance on a monitored service 100 implementing specific features by means of a chained operation of multiple components using a service graph illustrating a dependency between components constituting the monitored service 100. The control device 10 includes an acquisition unit 11 configured to acquire update information of the monitored service 100, a determination unit 13 configured to determine update convergence of the service graph, and a control unit 12 configured to shift the operation phase to a learning phase in which the service graph is updated when the update information has been received, and shift the operation phase to a detection phase in which anomalies are detected using the service graph when it is determined that the update of the service graph has converged.

### TECHNICAL FIELD

The present invention relates to a control device, a control method and a program.

### BACKGROUND ART

In recent years, a microservice architecture has been widely provided in which applications for providing services such as web or ICT services are divided for each feature as components and the components communicate with each other to make a chained operation. For microservice management, not only metric or log monitoring at a resource level but also monitoring at an application level is required. For example, event logs occurred while running an application and the metrics in the application (including the number of HTTP requests, the number of transactions and the waiting time for each request) are aggregated and monitored in the application, whereby it is possible to support anomaly detection and root cause analysis in a complicated microservice.

As an example of an application-level monitoring scheme, visualization of component traces for one request to the application has been proposed. This is called tracing. Non Patent Literatures 1 and 2 respectively disclose black box-based tracing software that acquires operation history data without modifying the application itself. Non Patent Literatures 3 and 4 respectively disclose annotation-based tracing software that acquires operation history data by modifying the application. By visualizing of various microservice traces as a series of flows and displaying to a maintenance engineer or a developer, it is possible to help discover unusual traces and root causes of anomalies.

### CITATION LIST

### Non Patent Literature

Non Patent Literature 1: B. Sang, J. Zhan, G. Lu et al., “Precise, Scalable, and Online Request Tracing for Multitier Services of Black Boxes”, IEEE Transactions on Parallel and Distributed Systems, vol. 23, no. 6, pp. 1159-1167, 2012.

Non Patent Literature 2: X. Zhao, Y. Zhang, D. Lion et al., “lprof: A Non-intrusive Request Flow Profiler for Distributed Systems”, 11th USENIX Symposium on Operating Systems Design and Implementation (OSDI '14), pp.629-644, 2014.

Non Patent Literature 3: B. H. Sigelman, L. A. Barroso, M. Burrows, P. Stephen-son, M. Plakal, D. Beaver, S. Jaspan, and C. Shanbhag. “Dapper, a large-scale distributed systems tracing infrastructure”, Technical report, Google, Inc., 2010.

Non Patent Literature 4: “Jaeger: open source, end-to-end distributed tracing”, [online], Internet <URL: https://www.jaegertracing.ic/>

### SUMMARY OF INVENTION

### Technical Problem

Application-level monitoring data keeps accumulating every time an application runs, and thus it is not practicable for a person to check each piece of data in real time. For finding suspiciously abnormal monitoring data out of pieces of monitoring data, a definition of normality and a difference between normality and anomaly are required, but it is difficult to manually extract a normal operation model from a very large amount of monitoring data. In particular, it is difficult to manually discover hidden operation dependencies that are not explicitly described in the monitoring data.

The inventors have proposed a method of estimating an inter-component dependency and creating a service graph representing dependencies between all components across the service by a Petri net in “Proposal of Service Graph Buildup based on Trace Data of Multiple Services” (IEICE Journal, Vol. 119, No. 438). Accordingly, it is possible to construct the service graph representing the inter-component dependency using the monitoring data. It is thought that it is possible to detect abnormal behaviors by detecting monitoring data not following the constructed service graph.

In a case where anomalies are detected using a service graph, it is necessary to update the service graph when an inter-component operation dependency is changed due to, for example, application update. However, it is difficult to keep the service graph in the latest state as a normal operation model while distinguishing between the application update and anomaly in the application.

The present invention is intended to deal with the problems stated above, and an object thereof is to keep a graph model representing an inter-component dependency in the latest state.

### Solution to Problem

According to one aspect of the present invention, provided is a control device for controlling an operation phase of a maintenance control system that performs maintenance on a service implementing specific features by means of a chained operation of multiple components using a service graph illustrating a dependency between components constituting the service, the control device including: an acquisition unit configured to acquire update information of the service; a determination unit configured to determine update convergence of the service graph; and a control unit configured to shift the operation phase to a learning phase in which the service graph is updated when the update information has been received, and shift the operation phase to a detection phase in which anomalies are detected using the service graph when it is determined that the update has converged in the service graph.

### ADVANTAGEOUS EFFECTS OF INVENTION

According to the present invention, it is possible to keep the graph model representing the inter-component dependency in the latest state.

### BRIEF DESCRIPTION OF DRAWINGS

FIG. 1 is a diagram illustrating one example of an overall configuration of a maintenance control system including a control device of the present embodiment.

FIG. 2 is a functional block diagram illustrating one example of a configuration of the control device.

FIG. 3 is a sequence diagram illustrating one example of a processing flow of the maintenance control system.

FIG. 4 is a flowchart illustrating one example of a processing flow of the control device.

FIG. 5 is a diagram illustrating one example of trace data.

FIG. 6 is a diagram in which components are represented by Petri nets.

FIG. 7 is a diagram representing an inter-component patent-progeny relationship by Petri nets.

FIG. 8 is a diagram representing an inter-component order relation by Petri nets.

FIG. 9 is a diagram representing an inter-component exclusive relationship by Petri nets.

FIG. 10 is a diagram illustrating one example of a service graph.

FIG. 11 is a diagram illustrating convergence determination based on a change in the number of nodes.

FIG. 12 is a diagram illustrating one example of a connection matrix in a Petri net.

FIG. 13 is a diagram illustrating one example of a hardware configuration of the control device.

### DESCRIPTION OF EMBODIMENTS

Hereinbelow, the present embodiment will be described with reference to drawings.

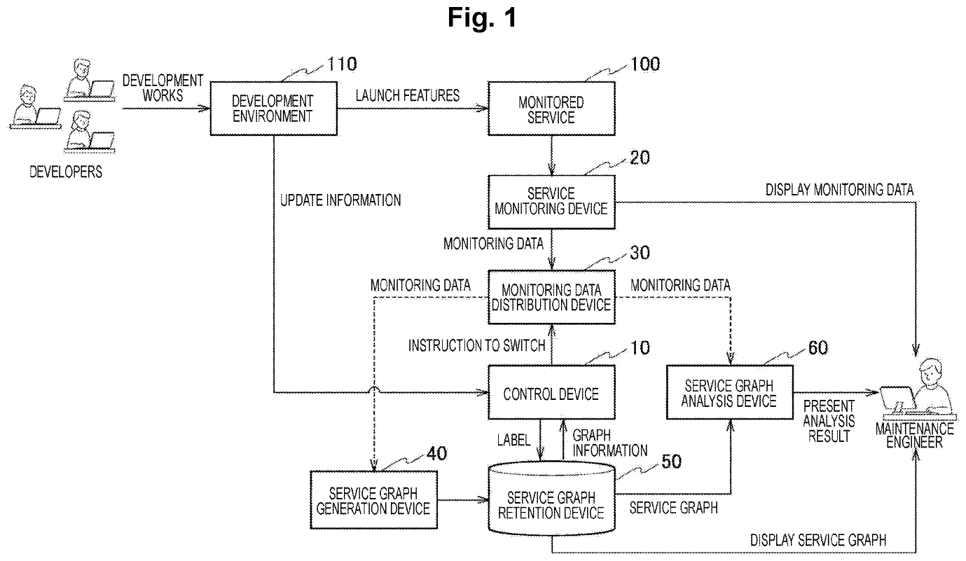

Referring to FIG. 1, an overall configuration of a maintenance control system including a control device 10 of the present embodiment will be described. The maintenance control system shown in FIG. 1 includes a control device a service monitoring device 20, a monitoring data distribution device 30, a service graph generation device a service graph retention device 50, and a service graph analysis device 60.

A monitored service 100 includes a plurality of components and implements specific features by a chain operation of the multiple components. A component is a program that has an interface capable of exchanging requests and responses with other components and is implemented in various program languages.

The developer develops and updates the monitored service 100 in development environment 110. When updating the monitored service 100, the development environment 110 sends an update timing notification to the control device 10.

The service monitoring device 20 is a device for monitoring the monitored service 100 at an application level, and for visualizing traces of the components for one request. The service monitoring device 20 can adopt technologies described in Non Patent Literatures 1 to 4. For example, the service monitoring device 20 records processing in each component of the monitored service 100 as a span element, and visualizes a flow of operations in the monitored service 100 for one request as trace data (hereinafter sometimes also referred to as “monitoring data”). A code for carrying a label is embedded in each component of the monitored service 100 to acquire the span element. The service monitoring device 20 displays the visualized monitoring data to a maintenance engineer. The maintenance engineer can check application-level behaviors of the monitored service 100 with the visualized monitoring data.

The monitoring data distribution device 30 receives the monitoring data from the service monitoring device 20, and distributes the monitoring data to the service graph generation device 40 or the service graph analysis device 60 according to an operation phase of the maintenance control system. More particularly, the monitoring data distribution device 30 distributes the monitoring data to the service graph generation device 40 in a learning phase, and to the service graph analysis device 60 in a detection phase. A service graph is updated based on the monitoring data from the service graph generation device 40 in the learning phase. The monitoring data is checked in the service graph by the service graph analysis device 60 in the detection phase. A service graph is a graph structure representing dependencies between components constituting the monitored service 100. The service graph can be used to represent a state transition of flows of operations in the monitored service 100. The monitoring data distribution device 30 switches distribution destinations of the monitoring data based on an instruction from the control device 10.

The service graph generation device 40 receives the monitoring data in the learning phase, estimates inter-component dependencies from the monitoring data, updates the service graph based on the estimated dependencies, and stores the service graph in the service graph retention device 50.

The service graph retention device 50 retains the service graph. The service graph retained by the service graph retention device 50 is displayed to the maintenance engineer, or used by the service graph analysis device 60 to analyze the monitoring data. A normal label is given to the service graph retained by the service graph retention device 50 in the detection phase, and is removed from the service graph in the learning phase. The service graph to which the normal label is given corresponds to a normal model in which the graph update converges and is determined.

The service graph analysis device 60 receives the monitoring data in the detection phase, determines whether a behavior is abnormal by checking executability of a state transition of the monitoring data in the service graph, and displays the analysis result to the maintenance engineer.

The control device 10 switches an operation phase of the maintenance control system on the basis of update information received from the development environment 110 and the convergence determination of the service graph. Specifically, when receiving update information of the monitored service 100 from the development environment 110 during the detection phase, the control device 10 shifts to the learning phase in accordance with the update, and issues an instruction to switch a distribution destination of the monitoring data to the service graph generation device 40. The control device 10 determines the update convergence of the service graph retained by the service graph retention device 50 during the learning phase, shifts to the detection phase when determining that the service graph update has converged, and issues an instruction to switch the distribution destination of the monitoring data to the service graph analysis device 60.

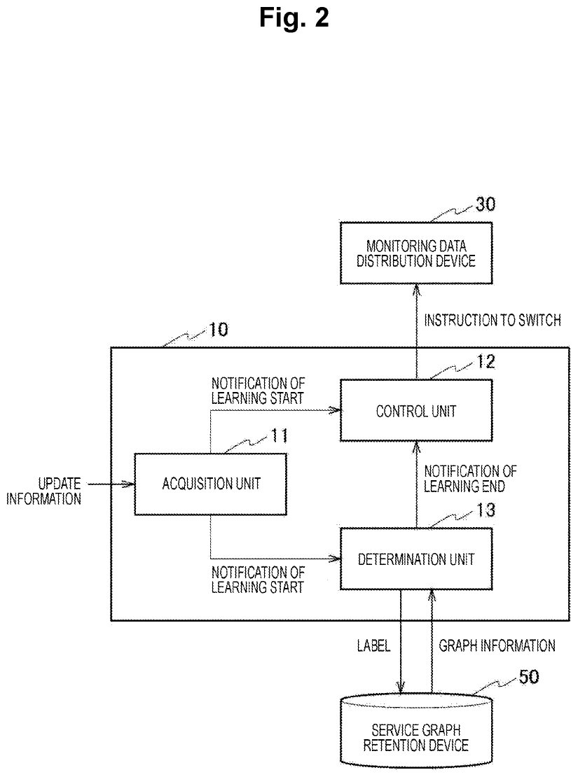

A configuration of the control device 10 will be described with reference to FIG. 2. The control device 10 illustrated in FIG. 2 includes an acquisition unit 11, a control unit 12, and a determination unit 13.

When acquiring the update information from the development environment 110, the acquisition unit 11 notifies control unit 12 and determination unit 13 of learning start in accordance with the update of the monitored service 100. The acquisition unit 11 may periodically request the update information for the development environment 110, or may notify the control device 10 of the update information when the development environment 110 updates the monitored service 100. When the acquisition unit 11 acquires the update information and notifies the learning start, the learning phase is initiated.

The control unit 12 transmits an instruction to switch the distribution destination of the monitoring data to the monitoring data distribution device 30 according to a phase. Specifically, the control unit 12 transmits, to the monitoring data distribution device 30, an instruction to start distribution of the monitoring data to the service graph generation device 40 when receiving a notification of the learning start from the acquisition unit 11, and transmits to the monitoring data distribution device 30 an instruction to start distribution of the monitoring data to the service graph analysis device 60 when receiving a notification of the learning end from the determination unit 13.

Upon receiving the notification of the learning start, the determination unit 13 deletes the normal label from the service graph retained by the service graph retention device 50, starts monitoring the service graph, and checks the update of the service graph. The determination unit 13 receives information on the service graph from the service graph retention device 50, monitors the service graph, and determines whether the update of the service graph has converged. In a case where no change is observed in the service graph retained by the service graph retention device 50 for at least a predetermined period of time, the determination unit 13 determines that the update of the service graph has converged. When it is determined that the update of the service graph has converged, the determination unit 13 gives a normal label to the service graph retained by the service graph retention device 50 and notifies the control unit 12 of the learning end. When the determination unit 13 determines that the update of the service graph has converged and notifies the learning end, the detection phase is initiated.

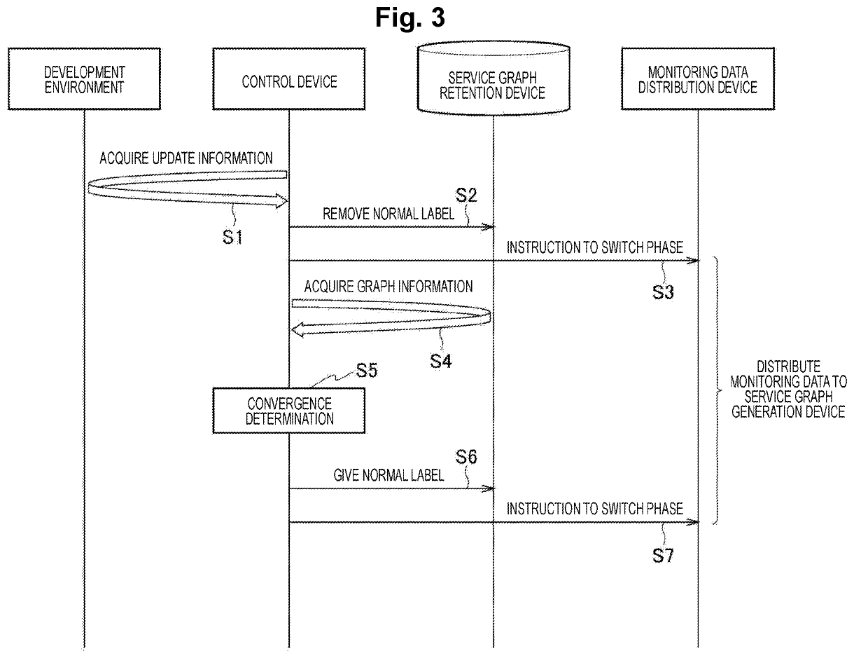

A flow of processing of the maintenance control system will be described with reference to a sequence diagram shown in FIG. 3.

In step S1, the control device 10 acquires the update information from the development environment 110. At this time, the maintenance control system is in the detection phase, and the monitoring data distribution device 30 distributes the monitoring data to the service graph analysis device 60.

The control device 10 removes a normal label from the service graph retained by the service graph retention device 50 in step S2, and sends, to the monitoring data distribution device 30, the instruction to switch the distribution destination of the monitoring data to the service graph generation device 40 in step S3.

Step S3 and subsequent steps correspond to the learning phase, in which the monitoring data is distributed to the service graph generation device 40. Distribution of the monitoring data to the service graph analysis device 60 is stopped. The service graph generation device 40 receives the monitoring data and starts update of the service graph retained by the service graph retention device 50.

The control device 10 receives the information on the service graph from the service graph generation device 40 in step S4, and determines whether the update of the service graph has converged in step S5.

The control device 10 repeats the processing of steps S4 and S5 until it is determined that the update of the service graph has converged.

When the update of the service graph has converged, the control device 10 gives a normal label to the service graph retained by the service graph retention device 50 in step S6, and sends, to the monitoring data distribution device 30, the instruction to switch the distribution destination of the monitoring data to the service graph analysis device 60 in step S7.

Step S7 and subsequent steps correspond to the detection phase, in which the monitoring data is distributed to the service graph analysis device 60. Distribution of the monitoring data to the service graph generation device 40 is stopped. The service graph analysis device 60 receives the monitoring data and starts anomaly detection of the monitoring data using the service graph retained by the service graph retention device 50.

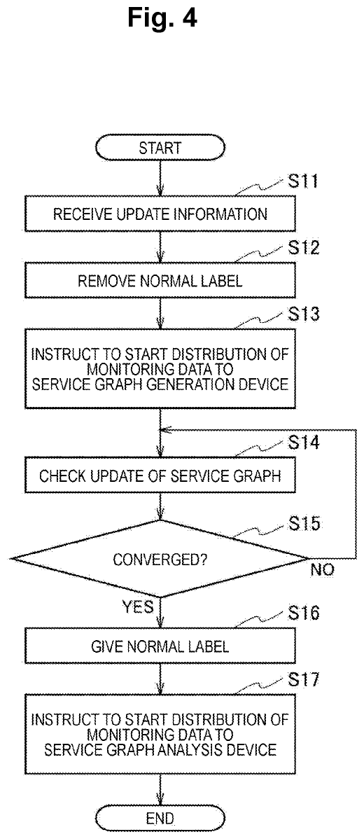

A processing flow of the control device 10 will be described below with reference to flowcharts shown in FIG. 4.

In step S11, the acquisition unit 11 receives the update information. Upon receiving the update information, the acquisition unit 11 notifies the control unit 12 and the determination unit 13 of the learning start.

In step S12, the determination unit 13 removes the normal label from the service graph retained by the service graph retention device 50.

In step S13, the control unit 12 issues the instruction to start the distribution of the monitoring data to the service graph generation device 40.

In step S14, the determination unit 13 checks the update of the service graph.

In step S15, the determination unit 13 determines whether the update of the service graph has converged.

The determination unit 13 repeats the processing of steps S14 and S15 in a case where the update of the service graph has not converged.

In a case where the update of the service graph has converged, the determination unit 13 gives the normal label to the service graph retained by the service graph retention device 50 in step S16. When it is determined that the update of the service graph has converged, the determination unit 13 notifies the control unit 12 of the learning end.

In step S17, the control unit 12 issues the instruction to start the distribution of the monitoring data to the service graph analysis device 60.

The service graph generated from the trace data (monitoring data) will be described below.

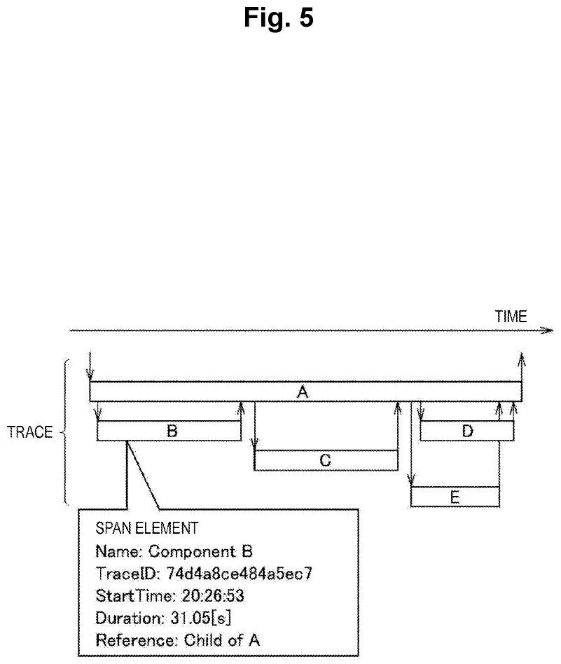

The trace data is a set of span elements constituting a series of processing from a request for the monitored service 100 to a response. For example, one piece of trace data from one request made by an end user to the monitored service 100 to a response is obtained. The span element is data in which time data of processing of each component and a parent-progeny relationship are recorded. FIG. 5 illustrates one example of the visualized trace data. In FIG. 5, a horizontal axis represents time, and a processing period of the component is represented by a rectangular width. Each of the five rectangles with letters A to E indicates the span element of each component. Arrows indicate exchanges of requests and responses between components. The span element includes, for example, information on a component name (Name), a trace ID (TraceID), a processing start time (StartTime), a processing period (Duration), and a relationship (Reference).

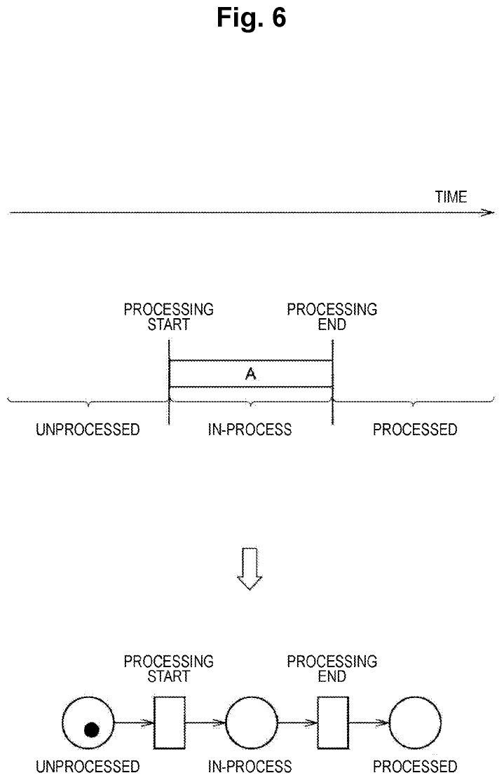

Referring to FIGS. 6 to 9, a method of representing a service graph based on inter-component dependencies will be described.

The service graph generation device 40 estimates an inter-component dependency from time information of each span element of the trace data, and represents a component-level service graph of the entire monitored service 100 by a Petri net on the basis of the estimated dependency. The Petri net is a two-part directed graph having two types of nodes, place and transition, connected by arcs. A variable called a token is given to the place. The transition transfers tokens of all the places existing before a certain place to all the successive places by firing.

In the present embodiment, a Petri net of one component is defined as illustrated in FIG. 6. Specifically, three types of states taken by the component include “unprocessed”, “in-process”, and “processed”, which are associated with places. A state transition of the component is represented by moving a token by firing (processing start or processing end) of the inter-place transition. The token is a black circle arranged at the unprocessed place in FIG. 6. When the component shown in FIG. 6 starts processing, the token is moved to the in-process place.

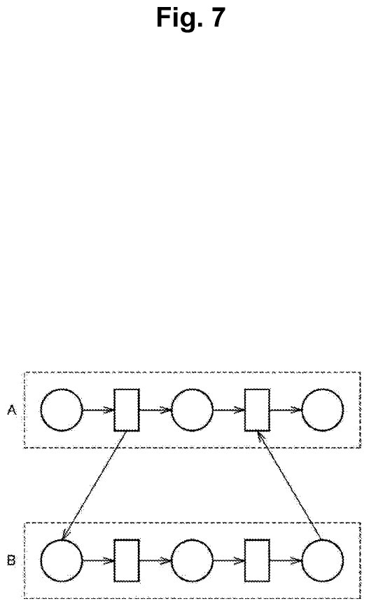

The inter-component dependency can be represented by adding an arc and a place to the Petri net of the components illustrated in FIG. 6. Specifically, as illustrated in FIGS. 7 to 9, a parent-progeny relationship, an order relation, and an exclusive relationship between components are expressed. The parent-progeny relationship is a relationship in which one component calls the other component. The order relation is a relationship in which one component is always executed after processing of the other component. The exclusive relationship is a relationship in which components never run in parallel.

A parent-progeny relationship between components A and B can be represented as illustrated in FIG. 7. An arc connects from a transition of processing start of the parent component A to an unprocessed place of the progeny component B, and another arc connects from a processed place of the progeny component B to a transition of processing end of the parent component A. It shows that the processing of the component B starts after the processing start of the component A, the component B enters a processed state after the processing end of the component B, and then the processing of the component A ends.

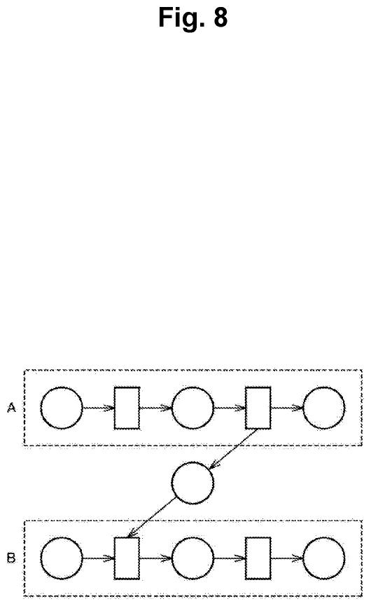

An order relation between the components A and B can be represented as illustrated in FIG. 8. New arc and new place are arranged at the transition of processing end of the component A, and another arc connects from the new place to a transition of processing start of the component B. It shows that the processing of the component B starts after the processing end of the component A.

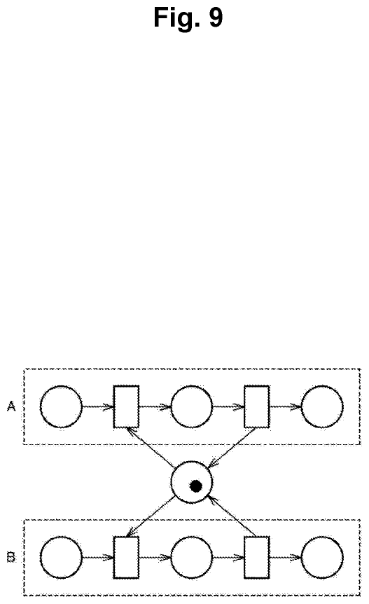

An exclusive relationship between the components A and B can be represented as illustrated in FIG. 9. A new place indicating a state in which both the component A and the component B are not being processed is arranged, and a token is arranged at the new place. Arcs respectively connect from transitions of processing end of the components A and B to the new place, and the other arcs respectively connect from the new place to transitions of processing starts of the components A and B. It shows that the processing of the component C or the component B starts after the processing end of the component B or the component C.

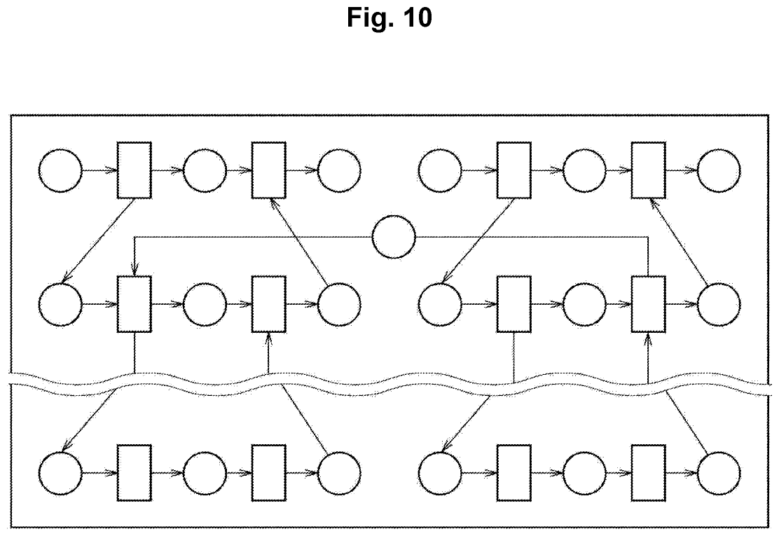

FIG. 10 illustrates one example of a service graph of the monitored service 100. All components constituting the monitored service 100 and inter-component dependencies are represented in the service graph of FIG. 10. When the monitoring data is distributed to the service graph generation device 40, the service graph generation device 40 compares the time data between span elements of sibling components with respect to each piece of the trace data included in the monitoring data, estimates the order relation or the exclusive relationship between the components, and updates the service graph. The service graph generation device 40 adds a graph representing a dependency by the method above for a newly discovered inter-component dependency, and removes a graph representing a dependency for a lost dependency.

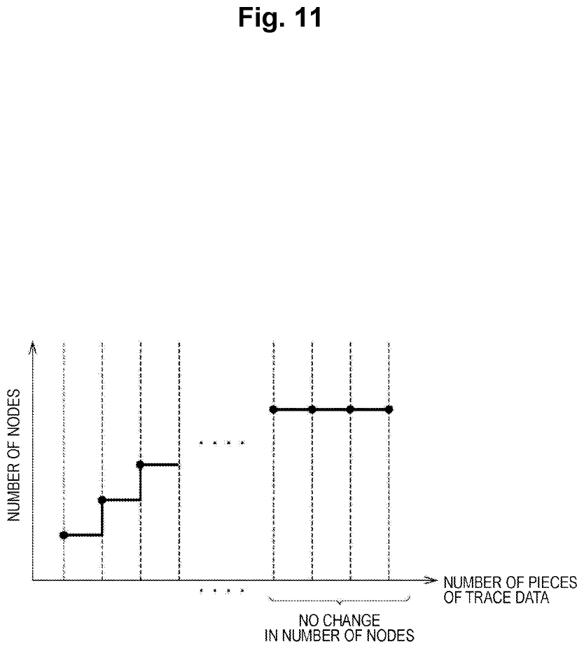

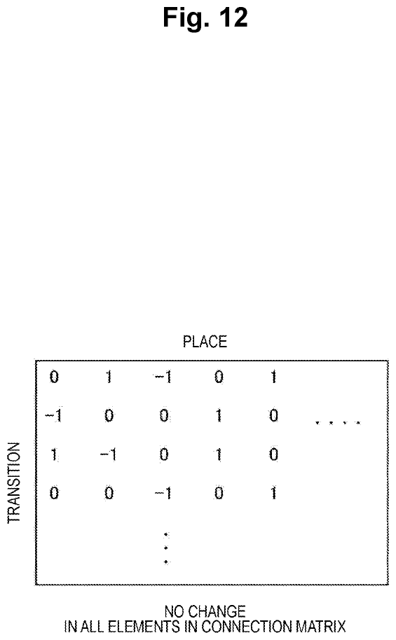

The control device 10 can determine whether the update of the service graph has converged by checking the number of nodes (the number of places+the number of transitions) of the service graph and the connection matrix in the Petri net. For example, the control device 10 determines that the update of the service graph has converged in a case where the number of nodes does not change as illustrated in FIG. 11 and all elements of the connection matrix in the Petri net illustrated in FIG. 12 do not change with respect to the distribution of a certain pieces of trace data. Since the connection matrix may change even if the number of nodes does not change, the control device 10 first monitors the number of nodes and checks each element of the connection matrix when the number of nodes does not change.

As described above, the control device 10 according to the present embodiment includes the acquisition unit 11 configured to acquire the update information of the monitored service 100; the determination unit 13 configured to determine the update convergence of the service graph; and the control unit 12 configured to shift the operation phase to the learning phase in which the service graph is updated when the update information has been received, and shift the operation phase to the detection phase in which anomalies are detected using the service graph when it is determined that the update has converged in the service graph. The control device 10 distributes the monitoring data to the service graph generation device 40 in the learning phase and distributes the monitoring data to the service graph analysis device 60 in the detection phase, such that the service graph indicating the dependency between components constituting the monitored service 100 can be maintained in the latest state.

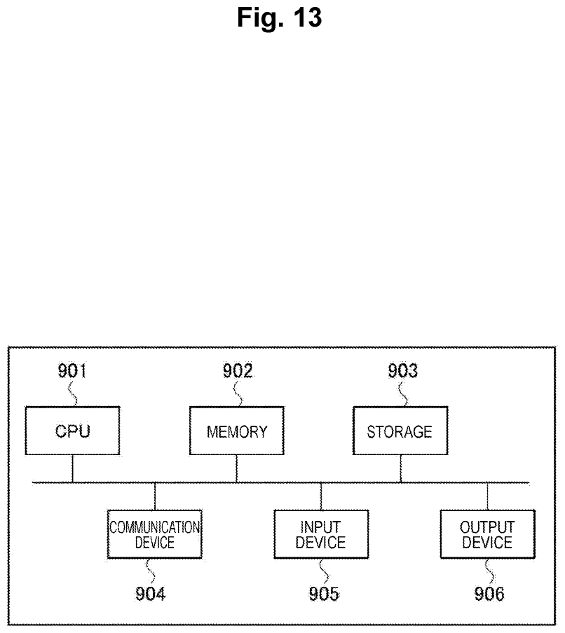

As the control device 10 described above, a general-purpose computer system can be used, for example, including a central processing unit (CPU) 901, a memory 902, a storage 903, a communication device 904, an input device 905, and an output device 906 as illustrated in FIG. 13. In this computer system, the CPU 901 executes a predetermined program loaded on the memory 902, thereby implementing the control device 10. This program can be recorded on a computer-readable recording medium such as a magnetic disk, an optical disk, or a semiconductor memory, or can be distributed via a network.

### REFERENCE SIGNS LIST

10 Control device
11 Acquisition unit
12 Control unit
13 Determination unit
20 Service monitoring device
30 Monitoring data distribution device
40 Service graph generation device
50 Service graph retention device
60 Service graph analysis device
100 Monitored service
110 Development environment

1. A control device for controlling an operation phase of a maintenance control system that performs maintenance on a service implementing specific features by means of a chained operation of multiple components using a service graph illustrating a dependency between components constituting the service, the control device comprising one or more processors configured to:
acquire update information of the service;
determine update convergence of the service graph; and
shift the operation phase to a learning phase in which the service graph is updated when the update information has been received, and shift the operation phase to a detection phase in which anomalies are detected using the service graph when it is determined that the update of the service graph has converged.

2. The control device according to claim 1, wherein
the maintenance control system is provided with a generation device that updates the service graph using monitoring data including information on a series of processing in the service, and an analysis device that detects anomalies from the monitoring data using the service graph, and
the control device is configured to distribute the monitoring data to the generation device during the learning phase, and distribute the monitoring data to the analysis device during the detection phase.

3. The control device according to claim 1, wherein
the service graph represents a state before, during and after processing of the component as places in a Petri net, represents processing start and processing end of the component as transitions in the Petri net, and represents a dependency between the components by arranging a new node and arc between the Petri nets of the components.

4. The control device according to claim 3, configured to determine that the update of the service graph has converged when the number of nodes in the service graph does not change and a connection matrix in the Petri net does not change for a certain period of time.

5. A control method by a control device for controlling an operation phase of a maintenance control system that performs maintenance on a service implementing specific features by a chained operation of multiple components using a service graph illustrating a dependency between components constituting the service, the control method comprising:
acquiring update information of the service;
determining update convergence of the service graph;
shifting the operation phase to a learning phase in which the service graph is updated when the update information has been received; and
shifting the operation phase to a detection phase in which anomalies are detected using the service graph when it is determined that the update of the service graph has converged.

6. A non-transitory computer readable medium storing one or more instructions causing a computer to operate as a control device for controlling an operation phase of a maintenance control system that performs maintenance on a service implementing specific features by a chained operation of multiple components using a service graph illustrating a dependency between components constituting the service to execute:
acquiring update information of the service;
determining update convergence of the service graph;
shifting the operation phase to a learning phase in which the service graph is updated when the update information has been received; and
shifting the operation phase to a detection phase in which anomalies are detected using the service graph when it is determined that the update of the service graph has converged.

7. The control method according to claim 5, wherein
the maintenance control system is provided with a generation device that updates the service graph using monitoring data including information on a series of processing in the service, and an analysis device that detects anomalies from the monitoring data using the service graph, and
the control method comprises:
distributing the monitoring data to the generation device during the learning phase, and distribute the monitoring data to the analysis device during the detection phase.

8. The control method according to claim 5, wherein
the service graph represents a state before, during and after processing of the component as places in a Petri net, represents processing start and processing end of the component as transitions in the Petri net, and represents a dependency between the components by arranging a new node and arc between the Petri nets of the components.

9. The control method according to claim 8, comprising:
determining that the update of the service graph has converged when the number of nodes in the service graph does not change and a connection matrix in the Petri net does not change for a certain period of time.

10. The non-transitory computer readable medium according to claim 6, wherein
the maintenance control system is provided with a generation device that updates the service graph using monitoring data including information on a series of processing in the service, and an analysis device that detects anomalies from the monitoring data using the service graph, and
the one or more instructions cause the computer to execute: distributing the monitoring data to the generation device during the learning phase, and distribute the monitoring data to the analysis device during the detection phase.

11. The non-transitory computer readable medium according to claim 6, wherein
the service graph represents a state before, during and after processing of the component as places in a Petri net, represents processing start and processing end of the component as transitions in the Petri net, and represents a dependency between the components by arranging a new node and arc between the Petri nets of the components.

12. The non-transitory computer readable medium according to claim 11, wherein the one or more instructions cause the computer to execute:
determining that the update of the service graph has converged when the number of nodes in the service graph does not change and a connection matrix in the Petri net does not change for a certain period of time.
